(19) United States
(12) Patent Application Publication
(10) Pub. No.: US 2008/0174548 A1
(43) Pub. Date: Jul. 24, 2008

(54) PUNCHING BAG APPARATUS AND METHOD

(76) Inventors: Scott Jones, Bristol (GB); Kevin Davies, Blackwood (GB)

Correspondence Address: Mr. Walter J. Tencza Jr., Suite 210, 100 Menlo Park, Edison, NJ, 08837, US

(21) Appl. No.: 12/056,401

(22) Filed: Mar. 27, 2008

(51) Int. Cl. G09G 5/00

(52) U.S. Cl. 345/156

(57) ABSTRACT

An apparatus is disclosed including a punching bag and at least a first force sensitive device attached to the punching bag. The apparatus may also include a computer processor, and a display device. The first force sensitive device communicates with the computer processor so that when a sufficient force contacts the first force sensitive device, a signal is sent from the first force sensitive device to the computer processor. The computer processor may be programmed to cause a first image to be displayed on the display device in response to a sufficient force contacting the first force sensitive device.

### FIELD OF THE INVENTION

This invention relates to methods and apparatus concerning electronic exercise equipment.

### BACKGROUND OF THE INVENTION

There are various electronic exercise devices known in the prior art.

### SUMMARY OF THE INVENTION

In at least one embodiment of the present invention, an apparatus is provided including a punching bag and at least a first force sensitive device attached to the punching bag. The apparatus may also include a computer processor, and a display device. In at least one embodiment, the first force sensitive device communicates with the computer processor so that when a sufficient force contacts the first force sensitive device, a signal is sent from the first force sensitive device to the computer processor. The computer processor may be programmed to cause a first image to be displayed on the display device in response to a sufficient force contacting the first force sensitive device.

The apparatus may include an attachment device and an elongated member having a first end and a second end. The punching bag may be attached by the attachment device to the first end of the elongated member, and the second end of the elongated member may be connected to the mounting device. The display device may be fixed to the mounting device.

The apparatus may further include one or more further force sensitive devices. The one or more further force sensitive devices may communicate with the computer processor so that when a sufficient force contacts any one of the one or more further force sensitive devices, a signal is sent from the force sensitive device contacted with sufficient force to the computer processor. The computer processor may be programmed to cause one or more further images to be displayed on the display device in response to a sufficient force contacting the one or more further force sensitive devices.

In at least one embodiment, the apparatus may include a computer memory. The computer processor may cause a first count to be kept in computer memory of a number of times that the first force sensitive device has been contacted with a sufficient force. The computer processor may cause the first count to be displayed on the display device. The computer processor may cause a timer to be displayed on the display device along with the first count. The first count may be kept during a first period of time, and a final first count may be stored in the computer memory when the first period of time has ended.

The computer processor may cause a second count to be kept in computer memory of a number of times that any of the first force sensitive device or the one or more further force sensitive devices have been contacted with a sufficient force during a second period of time, and may cause a final second count to be stored in the computer memory when the second period of time has ended. The computer processor may cause the first final count and the second final count to be displayed on the display device. The computer processor may be programmed to cause a graphic chart to be displayed on the display device, wherein the graphic chart represents the first final count and the second final count.

In at least one embodiment of the present invention, a method is provided which may include attaching a first force sensitive device to a punching bag, linking the first force sensitive device to a computer processor so that the first force sensitive device can communicate with the computer processor, wherein the first force sensitive device communicates with the computer processor so that when a sufficient force contacts the first force sensitive device, a signal is sent from the first force sensitive device to the computer processor. The method may further include displaying a first image on a display device in response to a sufficient force contacting the first force sensitive device.

The method may also include attaching the punching bag to a first end of the elongated member, and connecting a second end of the elongated member is connected to a mounting device, and mounting the mounting device to a wall. The method may also include fixing the display device to the mounting device.

In at least one embodiment of the method may include attaching one or more further force sensitive devices to the punching bag, and linking the one or more further force sensitive devices to the computer processor so that the one or more further force sensitive devices can communicate with the computer processor. The method may include displaying one or more further images on the display device in response to a sufficient force contacting any of the one or more further force sensitive devices.

The method may also include keeping a first count in a computer memory of a number of times that the first force sensitive device or any one or more further force sensitive devices has been contacted with a sufficient force, displaying the first count on the display device. A timer may be displayed on the display device along with the first count. A second count may be kept during a second period of time, and a second final count stored in the computer memory when the second period of time has ended. The first final count and the second final count may be displayed on a display device such as a computer monitor. A graphic chart may also be displayed on the display device, wherein the graphic chart represents the first final count and the second final count.

### BRIEF DESCRIPTION OF THE DRAWINGS

FIG. 1 shows a perspective view of an apparatus in accordance with an embodiment of the present invention;

FIG. 2 shows a block diagram of components for use with the apparatus of FIG. 1;

FIG. 3 shows an image which can be displayed on a display device or computer monitor of the apparatus of FIG. 1 in accordance with an embodiment of the present invention; and

FIG. 4 shows another image which can be displayed on a display device or computer monitor of the apparatus of FIG. 1 in accordance with an embodiment of the present invention.

### DETAILED DESCRIPTION OF THE DRAWINGS

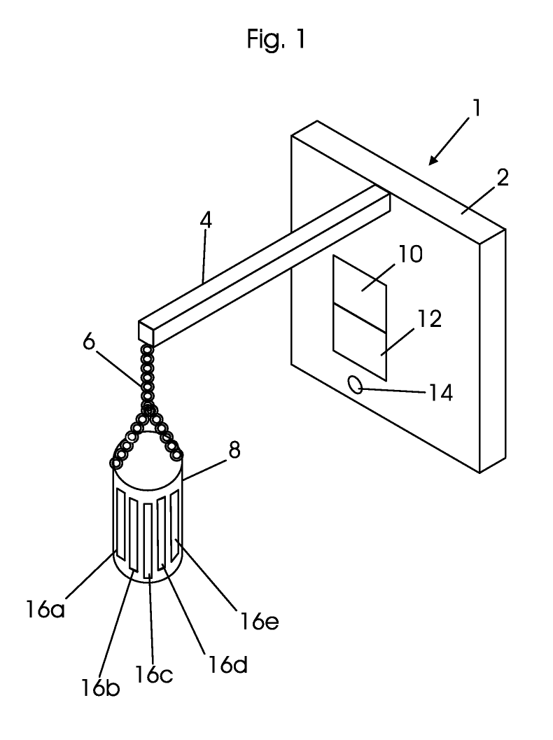

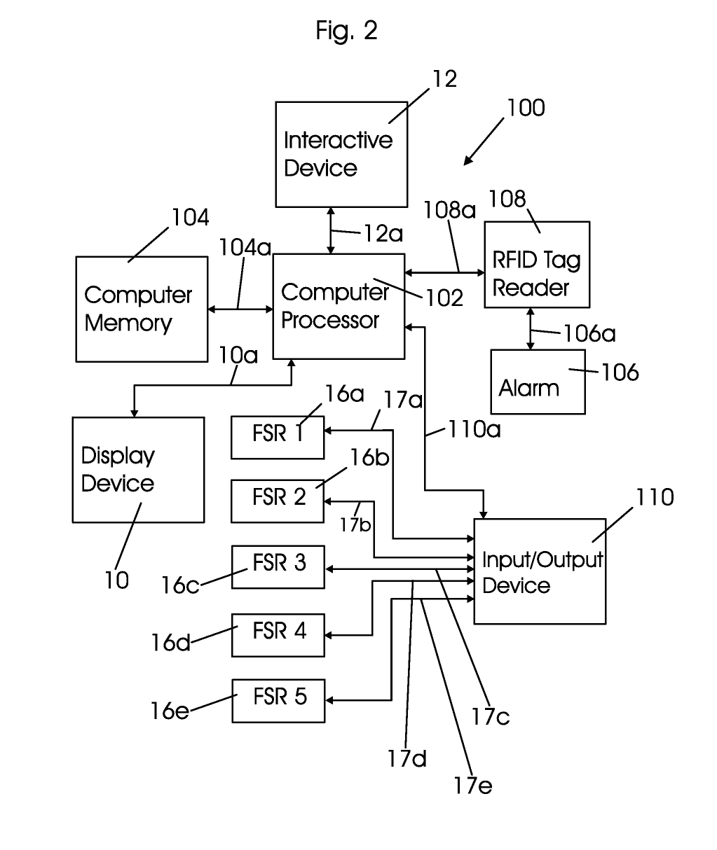

FIG. 1 shows a perspective view of an apparatus 1 in accordance with an embodiment of the present invention. FIG. 2 shows a block diagram 100 of components for use with the apparatus 1 of FIG. 1.

Referring to FIG. 1, the apparatus 1 includes a mounting device 2, an elongated member 4, attachment device 6, a punching bag 8, and FSR (force sensor resistor) devices 16a-16e. In one embodiment there may be twelve FSR devices, each similar to one of 16a-e, which may be placed substantially uniformly around the cylindrical surface of the punching bag 8 so that a substantial portion of the cylindrical surface of the punching bag 8 is covered by FSR devices. The mounting device 2 has a display device or computer monitor 10 mounted thereon and an interactive device 12, such as a computer keyboard, mounted thereon. There is also a button 14 which is for interaction for the user to start a timer run by computer software running on a computer processor 102 (shown in FIG. 2). The time remaining or time elapsed of the timer may be displayed on the computer monitor or display device 10 mounted on the mounting device 2. The mounting device 2 may be mounted to a structural wall of a building, such as in a gymnasium or other exercise facility.

FIG. 2 shows the interactive device 12, the computer processor 102, a computer memory 104, the display device 10, and an alarm 106 (which may be a piezo alarm or siren). The alarm 106 may be activated by a computer software program running on the computer processor 102 to cause an audio signal to be emanated from alarm 106 at various points in time, such as when a boxing session begins, when there are thirty seconds left in a boxing session, and when there are ten seconds left in a boxing session.

FIG. 2 also shows a radio frequency identification (RFID) tag reader 108, and an input/output device 110. The input/output device 110 receives a digital input and converts it into an analog output or receives an analog input and converts it into a digital output For example, the input/output device 110 receives analog signals from one or more of the FSRs 16a-e on communications links or input ports 17a-e, respectively. The input/output device 110 then converts the analog signals into digital signals which are sent to output port or communications link 110a and thereby to computer processor 102. The computer processor 102 receives these digital signals and can determine the strength of an impact to the appropriate FSR of FSRs 16a-e. The input/output device 110 provides a generic, convenient way to interface a personal computer (PC) with various devices.

The interactive device 12, computer memory 104, display device 10, an input/output device 110 are electrically connected to the computer processor 102 via communications links 12a, 104a, 10a, and 110a, respectively. The FSR devices 16a-e (there may be twelve FSRs in total surrounding the bag 8 but only five are visible in FIG. 1) are electrically connected to input/output device 110 via communications links 17a-17e, respectively. The RFID tag reader 108 Is connected directly to the computer processor 102 via communications link 108a and the alarm 106 is electrically connected to the RFID 108 via communications link 106a. The communications links 12a, 104a, 10a, 17a-e, 110a, 106a, and 108a may be any type of communications link or any combination of communications links such as electronic, hardwired, wireless, optical, or software.

The components 12, 104, 10, 102, 106, 108, and 110 may all be fixed to or housed within the mounting device 102, although all are not shown in the diagram of FIG. 1.

The computer processor 102, interactive device 12, computer memory 104, and display device 10 may be part of a laptop computer.

In operation, in at least one embodiment of the present invention, an individual hits, punches, kicks, or otherwise impacts one or more of FSRs 16a-e. The impact generates a signal on one or more of communications links/input ports 17a-e and is supplied to input output device 110 as one or more analog signals. If an analog signal meets a threshold, determined by the input/output device 110, the analog signal is converted into a digital signal and sent via the communications link 110a to the computer processor 102. The input/output device 110 may include a processor and/or computer software which sets a threshold.

In one embodiment of the present invention, the computer processor 102 by receiving a digital signal on the input or communications link 110a, interprets the force resistance from the appropriate FSR of 16a-e, and once the FSR receives a pressure above a certain threshold the computer software running on the computer processor 102 converts this into the form of a count. The threshold force or impact on an FSR required to cause a single count can be adjusted by a user by use of a rotary sensor which sets levels on the input/output device 110. The rotary sensor within input/output device 110 may have five preset thresholds which are known to the user as levels. In addition the computer processor 102 may be programmed so that as the user rotates the rotary sensor, the computer processor 102 receives a signal from the input/output device 110 which the computer processor 102 uses to produce an image on the computer monitor 10 which shows an indicia of the increase or decrease in levels.

In one embodiment, a signal will be received from the FSR that was contacted, and supplied to the input/output device 110. The input/output device 110 is programmed to receive signals from the FSRs 16a-e (and any further number of sensors), and the computer processor 102 is programmed to count the number of times all of the FSRs are contacted in a time period or session, such as a boxing session. In one embodiment, the computer processor 102 displays a current count, a time remaining, user statistics which are input by the user upon registering with the processor 102 and this information is saved to its own unique RFID tag. The computer processor 102 may also be programmed to displays the current count, counted rounds, the previous ten counted rounds and the user's top five since the user started using the equipment

The RFID tag reader 108 can be used to scan in a user's tag or identification card into the computer processor 102 or into the computer memory 104, at a time of registration. The identification card or tag can then later be used to log a user into a computer software system running on the computer processor 102. The RFID tag reader 108 can recall the users statistical information and previous counts, and also their top five counts. The RFID tag reader may also be used to add individual users. For example by presenting a new tag you can enter an administrative mode in the computer software system running on the computer processor 102 which allows a user to enter his/her statistics which may be comprised of NAME, AGE, LOCATION, WEIGHT, HEIGHT and then that information may then saved to the computer memory 104, and the tag may be displayed on the display device 10 every time the user logs in. In addition, the information and all the users' counts may be saved by the computer processor 102 to the computer memory 104.

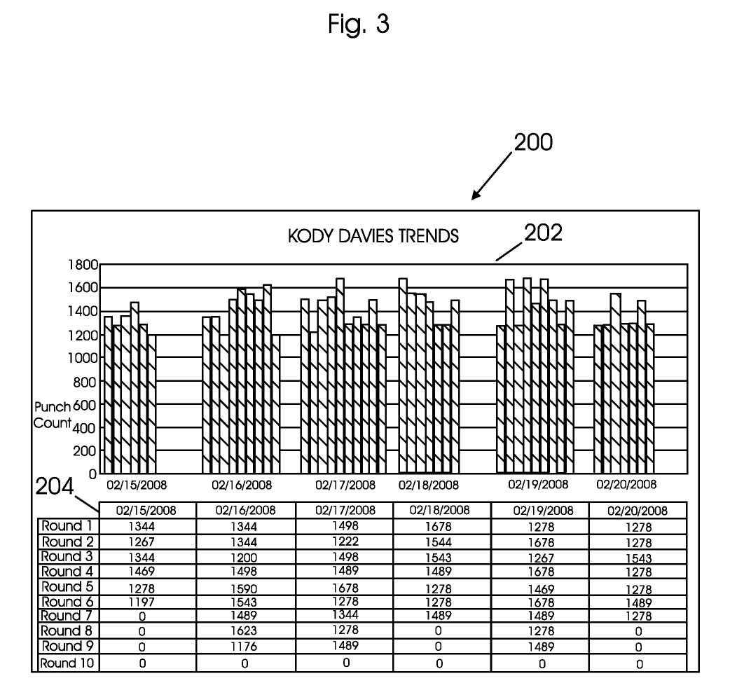

In one embodiment, at any time the user can log into an administrative mode and view all his/her results since they started using the apparatus 1. These results can be viewed on display device 10 or printed in terms of number and/or graph in response to a request to view trends of their success, as will be described with reference to FIG. 3. The statistics are also typically saved into the computer memory 104 and are updated every time the user uses the apparatus 1. Results can be saved since the user first became a new user. The user can then review their counts via the display device 10 in the form of a numerical order or a graph to show trends of there success, such as will be described with reference to FIG. 3.

In at least one embodiment, there are five different levels in which there are five different thresholds of count. Level one is tapping the punching bag 8 and is ultra sensitive. An increase in level means an increase in how hard a FSR is contacted. To reach the fifth level, an FSR of FSRs 16a-e on the punching bag 8 needs to be punched or kicked much harder. The piezo 106, which may be an audible piezo, can be used to alert the user of the time remaining in which to hit the punching bag 8. For example, the piezo 106 may audibly beep or make some other sound with thirty seconds remaining and with ten second remaining.

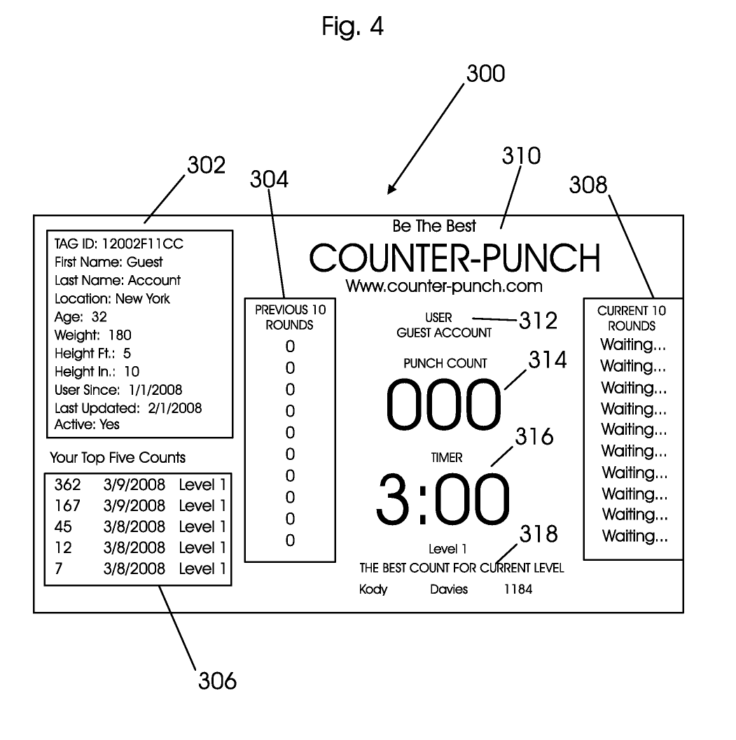

The elongated member 4 and the mounting device 2 may be called a bracket, and they may hold up the punch bag 8 and incorporate a laptop (including processor 102, display device 10, interactive device 12, and computer memory 104). The display device 10 may show how much time is remaining in the period in which to hit the punching bag 8, such as will be described with reference to FIG. 4. The display device 10 may display the time remaining, current punch count, current ten rounds, previous ten rounds, top five counts and current user's stats, such as will be described with reference to FIG. 4.

FIG. 3 shows an image 200 which can be displayed on the display device or computer monitor 10 of the apparatus 1 of FIG. 1 in accordance with an embodiment of the present invention. The image 200 includes a bar chart 202 and a table 204. The bar chart 202 has a y-axis labeled with numbers of punches or punch count from “0” to “2000+” and an x-axis labeled with a particular date. The are a plurality of bars for each date corresponding to a plurality of time periods, sessions or rounds, on that particular date. For example, for the date of “02/15/2008” (Feb. 15, 2008) there are six bars which correspond to six rounds on that date. Similarly for the dates of 02/15/2008-02/20/2008 there are nine, nine, seven, nine, and seven bars, respectively, which correspond to that nine, nine, seven, nine, and seven rounds or sessions, respectively.

The table 204 shows data corresponding to the bar chart 202. The table 204 has a header row with dates, and a header column with round number. Under each date, a column of punch count data appears. For example, under “02/15/2008”, the first column of data shows 1344, 1267, 1344, 1469, 1278, and 1197, indicating the number of punches or punch count for the rounds 1, 2, 3, 4, 5, and 6 respectively on the date of Feb. 15, 2008. Similarly, punch count data for dates 02/16/2008-02/20/2008 appears in the remaining data columns.

The image 200 has a heading “KODY DAVIES TRENDS” which indicates that the data referred to in the bar chart 202 and table 204 pertains to a person or user named “KODY DAVIES” and to any trend that may be seen from the data. The computer processor 102 may be programmed to cause the image 200 to be displayed on the display device or computer monitor 10 in response to an administrator user presenting an administrator Tag followed by the user's Tag of which you would like to recall data for. A computer program in accordance with an embodiment of the present invention may be used to display the image 200 on the display device 10 or to store the data referred to in the image 200.

FIG. 4 shows an image 300 which can be displayed on a display device or computer monitor 10 of the apparatus 1 of FIG. 1 in accordance with an embodiment of the present invention. The image 300 includes sections 302, 304, 306, 308, 310, 312, 314, 316, and 318.

Section 302 refers to user identification information for someone using the apparatus 1. The section 302 includes a tag identification, a first and last name, a location, an age, a weight, and a height (in ft. and inches) for a user of apparatus 1. The section 302 also includes a date the apparatus 1 was first used by the user, a date when user information was last updated for the user, and an indication of whether the user is active meaning the user uses the apparatus 1, as information can be stored even if the user has stopped using the apparatus 1.

Section 304 shows punch counts for the current user for the last full set of ten rounds, time periods, or sessions. Section 306 shows the top five punch counts for this user, and the date and level for each of the top five punch counts. Section 308 shows punch counts for the user for the current set of ten rounds. Section 310 shows identification and advertising information regarding the system and/or apparatus 1. Section 312 identifies the user first and last name. Section 314 shows the current punch count. Section 316 shows the amount of time left or the amount of time elapsed in a particular round or session. Finally section 318 shows the level for the current round, the best punch count for the current level, the name of the person who achieved the best punch count for the current level, and the punch count achieved.

The computer processor 102 may be programmed to cause the image 300 to be displayed on the display device or computer monitor 10 in response to a user logging on to the apparatus 1 by presenting their tag. A computer program, in accordance with an embodiment of the present invention, may be used to display the image 300 on the display device 10 or to store the data referred to in the image 300.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a punching bag;
a first force sensitive device attached to the punching bag;
a computer processor; and
a display device;
wherein the first force sensitive device communicates with the computer processor so that when a sufficient force contacts the first force sensitive device, a signal is sent from the first force sensitive device to the computer processor;
and wherein the computer processor is programmed to cause a first image to be displayed on the display device in response to a sufficient force contacting the first force sensitive device.

2. The apparatus of claim 1 further comprising
an attachment device;
and an elongated member having a first end and a second end;
wherein the punching bag is attached by the attachment device to the first end of the elongated member; and
and wherein the second end of the elongated member is connected to a mounting device.

3. The apparatus of claim 1 wherein
the display device is fixed to the mounting device.

4. The apparatus of claim 1 further comprising
one or more further force sensitive devices;
and wherein the one or more further force sensitive devices communicate with the computer processor so that when a sufficient force contacts any one of the one or more further force sensitive devices, a signal is sent from the force sensitive device contacted with sufficient force to the computer processor;
and wherein the computer processor is programmed to cause a one or more further images to be displayed on the display device in response to a sufficient force contacting the one or more further force sensitive devices.

5. The apparatus of claim 1 further comprising
a computer memory;
and wherein the computer processor causes a first count to be kept in computer memory of a number of times that the first force sensitive device has been contacted with a sufficient force;
and wherein the computer processor causes the first count to be displayed on the display device.

6. The apparatus of claim 4 further comprising
a computer memory;
and wherein the computer processor causes a first count to be kept in computer memory of a number of times that any of the first force sensitive device or the one or more further force sensitive devices have been contacted with a sufficient force;
and wherein the computer processor causes the first count to be displayed on the display device.

7. The apparatus of claim 6 wherein
the computer processor causes a timer to be displayed on the display device along with the first count.

8. The apparatus of claim 6 wherein
the computer processor causes the first count to be kept during first period of time, and causes a final first count to be stored in the computer memory when the first period of time has ended;
wherein the computer processor causes a second count to be kept in computer memory of a number of times that any of the first force sensitive device or the one or more further force sensitive devices have been contacted with a sufficient force during a second period of time, and causes a final second count to be stored in the computer memory when the second period of time has ended;
and wherein the computer processor causes the first final count and the second final count to be displayed on the display device.

9. The apparatus of claim 8 wherein
the computer processor is programmed to cause a graphic chart to be displayed on the display device, wherein the graphic chart represents the first final count and the second final count.

10. A method comprising:
attaching a first force sensitive device to a punching bag;
linking the first force sensitive device to a computer processor so that the first force sensitive device can communicate with the computer processor;
wherein the first force sensitive device communicates with the computer processor so that when a sufficient force contacts the first force sensitive device, a signal is sent from the first force sensitive device to the computer processor; and
further comprising displaying a first image on a display device in response to a sufficient force contacting the first force sensitive device.

11. The method of claim 10 further comprising
attaching the punching bag to a first end of the elongated member; and
connecting a second end of the elongated member is connected to a mounting device; and
mounting the mounting device to a wall.

12. The method of claim 11 further comprising
fixing the display device to the mounting device.

13. The method of claim 10 further comprising
attaching one or more further force sensitive devices to the punching bag;
linking the one or more further force sensitive devices to the computer processor so that the one or more further force sensitive devices can communicate with the computer processor;
wherein the one or more further force sensitive devices communicate with the computer processor so that when a sufficient force contacts any one of the one or more further force sensitive devices, a signal is sent from the force sensitive device contacted with sufficient force to the computer processor;
and further comprising displaying one or more further images on the display device in response to a sufficient force contacting any of the one or more further force sensitive devices.

14. The method of claim 10 further comprising
keeping a first count in a computer memory of a number of times that the first force sensitive device has been contacted with a sufficient force;
displaying the first count on the display device.

15. The method of claim 13 further comprising
keeping a first count in a computer memory of a number of times that any of the first force sensitive device or the one or more further force sensitive devices have been contacted with a sufficient force;
and displaying the first count on the display device.

16. The method of claim 15 further comprising
displaying a timer on the display device along with the first count.

17. The method of claim 15 wherein
keeping the first count during a first period of time, and storing a final first count in the computer memory when the first period of time has ended;
keeping a second count during a second period of time, and storing a second final count in the computer memory when the second period of time has ended;
wherein the second count is a number of times that any of the first force sensitive device or the one or more further force sensitive devices have been contacted with a sufficient force during the second period of time;
and further comprising displaying the first final count and the second final count on the display device.

18. The method claim 17 further comprising
displaying a graphic chart on the display device, wherein the graphic chart represents the first final count and the second final count.
